(19) United States
(12) Patent Application Publication
(10) Pub. No.: US 2014/0164583 A1
(43) Pub. Date: Jun. 12, 2014

(54) Providing Policy Data to a Computer

(71) Applicant: 1E LIMITED, London (GB)

(72) Inventors: Dave Harding, London (GB); Mark Blackburn, Maidenhead (GB)

(73) Assignee: 1e Limited, London (GB)

(21) Appl. No.: 13/712,738

(22) Filed: Dec. 12, 2012

(51) Int. Cl. H04L 29/08

(52) U.S. Cl. CPC H04L 29/08981
USPC 709/222

(57) ABSTRACT

A network comprises a plurality of computers including a first computer and a target computer. It also has a source of a plurality of policies, and an arrangement which installs policies on the computers of the network. The first computer has program code for accessing the source and for selecting one of the policies. The source responds to the selection to provide the selected policy to the installing arrangement. The installing arrangement has program code for automatically installing the selected policy on the target computer.

### TECHNICAL FIELD

The present invention relates to a method, system and computer programs for supplying policy data to a computer in a network.

### BACKGROUND

It is known to provide policies to machines in a network. The machines may be mobile telephones or general purpose computers, for example PCs. In some known systems a server stores policies for machines in the network and the policies are deployed to the machines under the control of a network administrator

### SUMMARY

In accordance with one aspect of the present invention, there is provided a method of providing a policy to a target computer in a network with a plurality of computers including a first computer, a target computer, a source of data defining a plurality of policies, and an installing arrangement which installs policies on the computers of the network, the method comprising:

accessing the source from the first computer and selecting one of the policies for provision to the target computer;

responding, by the source, to the selection to provide the selected policy to the installing arrangement; and

automatically installing the selected policy on the target computer using the installing arrangement.

In accordance with another aspect of the present invention, there is provided a network comprising a plurality of computers including:

a first computer,

a target computer,

a source of data defining a plurality of policies, and

an installing arrangement which installs policies on the computers of the network,

wherein the first computer has program code for accessing the source from the first computer and for selecting one of the policies for provision to the target computer,

wherein the source has program code for responding to the selection to provide the selected policy to the installing arrangement, and

wherein the installing arrangement has program code for automatically installing the selected policy on the target computer.

In accordance with yet another aspect of the present invention, there is provided a non-transitory computer readable medium storing instructions which, when run on a computer in a network with a plurality of computers including a first computer, a target computer, a source of policies and an arrangement which installs policies on the computers of the network, execute a method that:

responds to a request from the first computer to require an identifier of the user of the target computer;

on receipt of the identifier of the user, accesses from the asset database the identifier of the target computer;

in response to the identifier of the target computer, provides to the first computer a list of policies appropriate to the identified target machine; and

responds to selection of a policy at the first computer to provide the selected policy and the identifier of the target computer to the installing arrangement.

The invention allows users to select policies they require from a policy server and to automatically install them on a target computer using a machine other than the target computer.

Further features and advantages of the invention will become apparent from the following description of illustrative embodiments of the invention, given by way of example only, which is made with reference to the accompanying drawings.

### BRIEF DESCRIPTION OF THE DRAWINGS

FIG. 1 is a schematic block diagram of a network;

FIG. 2 is a schematic flow diagram of a process in accordance with an example of the invention;

FIG. 3 is a schematic flow diagram of a process in accordance with an example of the invention carried out at a shopping server of the network of FIG. 1; and

FIG. 4 is a schematic block diagram of a computer as used in the network of FIG. 1.

### DETAILED DESCRIPTION

Policies

Examples of the present invention concern the provision of policies to computers in a network. A policy is a setting or a group of settings for a computer which controls one or more functions of the computer. For example a power control policy may define the circumstances when a computer changes to a lower power setting from a higher power setting. A policy may define sources of data the computer can or cannot access. A policy may define other matters.

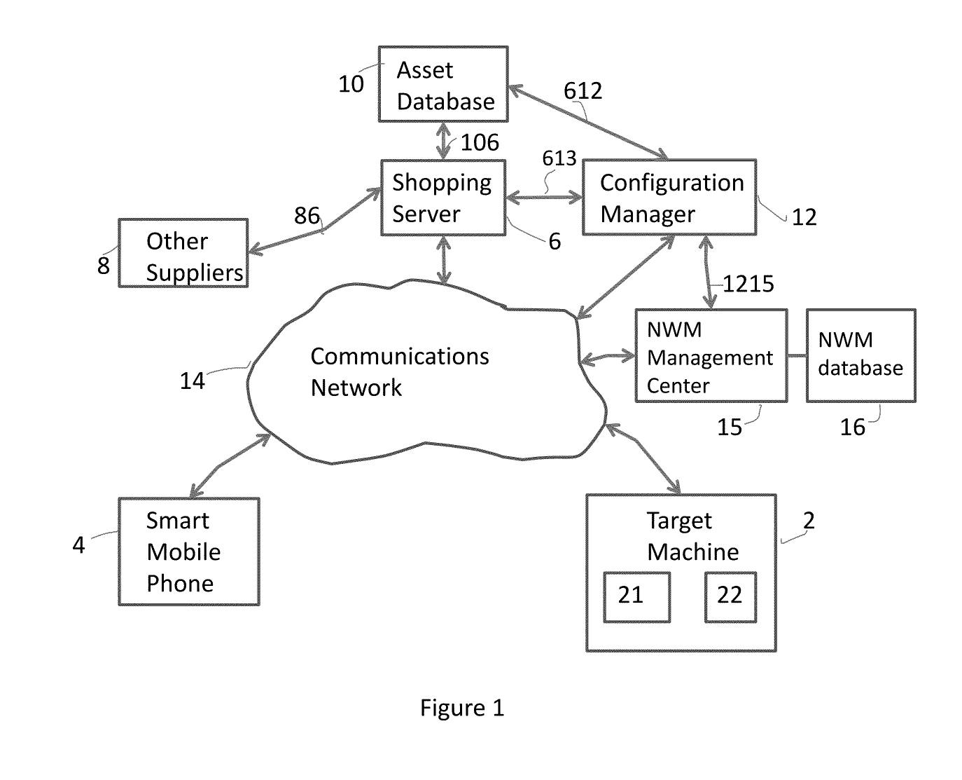

An Illustrative Network—FIG. 1

A user uses a computer 2, herein referred to as a target machine. In this example the target machine 2 is a desk top machine at the user's normal place of business. The user also has another computing machine 4, in this example a “smart” mobile phone (also known as a cell phone) which has a web browser.

The mobile phone 4 and the target machine 2 are connected to, or connectable to, a communications network 14. The communications network in this example comprises a mobile telephone network in which the mobile phone 4 operates, and an enterprise network of the user's business comprising other computers (not shown). The enterprise network is coupled to the mobile telephone network in known manner for example the public telephone system. The enterprise network may also be connected to the Internet and/or other networks in known manner.

Also connected to the network 14 are a server 6 herein referred to as a shopping server, a systems management tool 12, for example a Systems Management Server or Configuration Manager as provided by Microsoft Corporation. The shopping server is coupled to an asset data base 10 which may be a data base of the systems management tool 12.

The asset data base 10 in this example provides data correlating the computers of the network with identifiers identifying the respective users of the computers. It also provides data identifying the types of the computers; for example Windows PCs and Apple MACs amongst other types.

The shopping server is a source, or part of a source, of policies in this example. For that purpose the server has a data base of policies associated with identifiers of types of computers. The source may additionally comprise a server or servers 8 in which case the shopping server 6 may direct communications from the mobile telephone 4 to the server(s) 8. Alternatively, the shopping server may store other software but not policies for the computers of the network and direct requests for policies to the server(s) 8. Policies are assigned to single computers or to groups of computers. For each computer or group, the source of policies provides a list of one or more policies for different functions of the computer or group, the policies being suitable for the type of the computer. The policies may be the same for all computers of the same type regardless of the user.

Alternatively, some policies may be personalized for the user or groups of users.

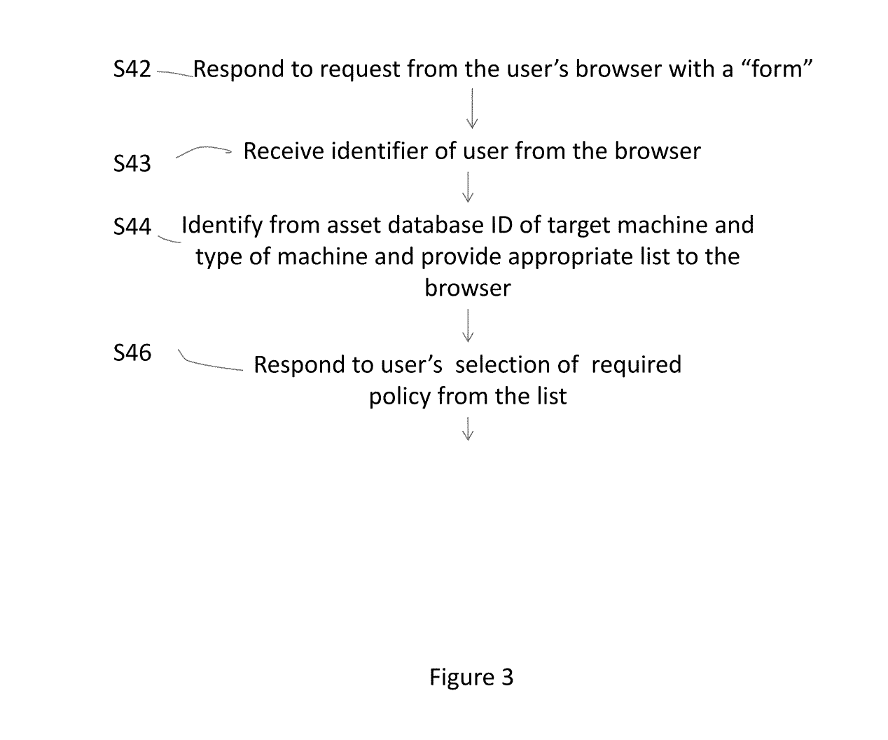

The shopping server may be an HTTP server which is a standard web server software such as Microsoft Internet Information Server. The shopping server has a server process for listening for incoming TCP connections from clients, in this example the mobile phone 4. It also has an HTML webpage form for presentation to the mobile phone. How to provide such a server process and form is known: see for example “Computer Networks, Third Edition by Andrew S Tanenbaum, Sections 7.6.2, 7.6.3 et seq.”. The user uses the form to obtain a list of policies and to select the policy required. This will be described in more detail with reference to FIG. 3.

The asset database 10 is shown coupled to the shopping server 6 by a communications link 106. The shopping server 6 is shown coupled to the systems management tool 12 by a communications link 613. The systems management tool 12 is connected to the asset database 10 by a link 612. The shopping server 6 is shown coupled to the server(s) 8 by a communications link 86. Such links may be provided by the communications network 14.

Some examples of the network include a NightWatchman (NWM) management center 15 having an NWM database 16. Such an NWM management center and NWM database 16 are provided by 1E limited. (NightWatchman is a Registered Trade Mark of 1E Limited). The NWM database 16 stores power management policies. The NWM management center 15 may be linked to the configuration manager 12. It may also be linked to the communications network 14.

The target machine may have an agent 21 of the systems management tool. Additionally or alternatively, the target machine may have an NWM agent 22 which interacts with the NightWatchman management center 15. NightWatchman is, amongst other functions, a power control system which controls power consumption of computers in accordance with power control policies.

The NWM center interacts with the configuration manager via the network 14, but may interact directly via the a link 1215.

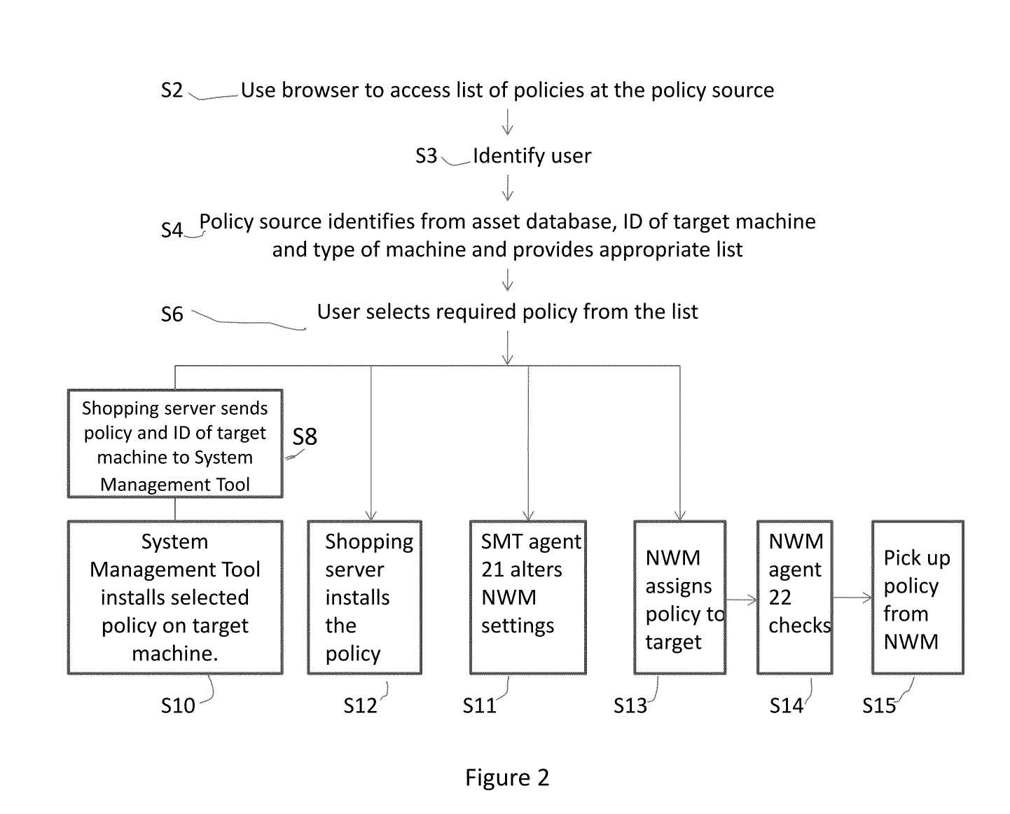

Providing a Policy to the Target Computer—FIG. 2

Consider the following hypothetical scenario. The user of the target computer 2 has left his place of work and inadvertently left the target computer in a full power state. He wishes to apply a power control policy to the target computer.

The user uses S2 the web browser on his smart mobile phone to access the shopping server. The user needs to be authenticated by authentication data, for example an identifier of the use. On contacting the shopping server, The authentication data is sent S3. The user may provide the identifier which identifies him. Alternatively, the identifier may be held on the mobile phone and automatically sent to the shopping server. The identifier may be a username and password. It could be any other piece of authentication data that the system will accept as authenticating the user such as a smart card certificate, a fingerprint or any other identifying data.

The shopping server uses S4 the asset database 10 and the identifier of the user to determine the identifier of the target machine and the type of the machine. The shopping server uses that information to provide the smart phone with access to a list of policies suitable for or allocated to the user's target machine. The list may be unique to the target machine or the group to which the machine belongs or a standard list for a type of machine.

The user selects S6 the required policy, in this case a power control policy.

The policies identified in the list may be stored in the shopping server 6 or be provided by the other suppliers or servers 8 and/or stored in the NWM database 16.

Automatic Installation of the Policy

In one example the shopping server provides S8 the selected policy and the identifier of the target computer to the system management tool which automatically installs the policy on the target computer in known manner.

In another example the shopping server itself has installation software and automatically installs S12 the policy.

Another example uses NightWatchman.

In one version the systems management tool has an agent 21 on the target machine which the shopping server causes to run S11 a NightWatchman command line locally on the target machine 2 to alter the NightWatchman settings, thereby affecting the policy.

In another version, the NightWatchman Management center database 16 is modified S13 in response to the selection of a policy at the shopping server such that a specific power management policy stored in the NightWatchman database is assigned to the target machine. The NWM agent 22 on the target machine 2 periodically checks S14 with the NightWatchman Management center 15 for policy; it will notice the change and then download and apply S15 the new policy.

Computer Programs

The invention also provides computer programs which when run on the computers of the network implement the procedures described above. The computer programs are stored on a non transitory carrier, for a computer readable medium for example a hard disk, an optical disc, a magneto-optical disk, a compact disc, a magnetic tape, electronic memory including Flash memory, ROM and RAM, a RAID or any other suitable computer readable storage device.

The smart mobile phone has standard browser software for accessing the shopping server and selecting a policy from a list. The target machine has standard software for enabling the installation of a policy. For example it could be Active Directory Group Policy (which is included with every version of Windows) and/or if the target machine interacts with NightWatchman software the target machine has a NightWatchman client agent.

Shopping Server Program—FIG. 3

The shopping server has program code for carrying out the process of FIG. 3.

In step S42, a process at the shopping server 6 listens for a request from the user's browser on the cell phone 4 for access to a web form. The server 6 responds by presenting the form to the cell phone. The form includes an input box for entering the identifier of the user. In step S42, the user enters the identifier which is received by the server 6. In step S44, the server 6 accesses the asset database 10 to determines the identifier the user's target machine 2 and the type of the machine. The server then finds and presents the appropriate list of policies to the user's browser at the cell phone 4. The user at step S46 selects the required policy from the list. The server 6 responds in step S48 to the selection by sending the policy with the identifier of the target machine to the system management tool 12 for automatic installation as discussed above with reference to FIG. 2.

A Computer

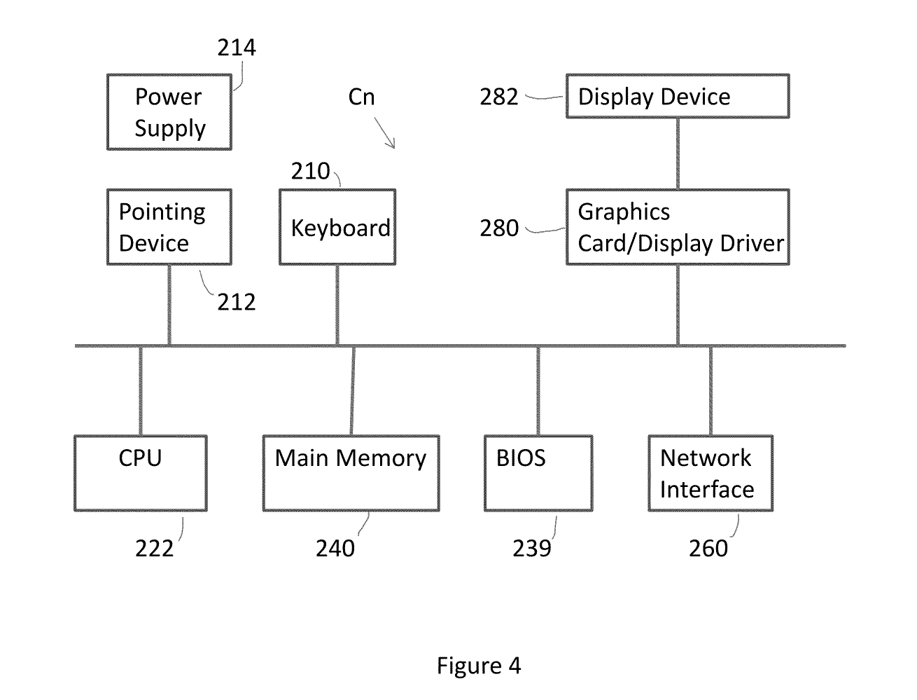

Referring to FIG. 4 an illustrative one of the computers , for example target 2 comprises, amongst other items: a CPU 222; a main memory 240 for example a hard disk drive or other storage device, for example electronic memory; a network interface 260; a display driver 280 coupled to a display device 282; human interface devices or input devices for example a keyboard 210 and a pointing device 212; and one or more busses 216; The items are conventional and interact via the buss(es) in a conventional way. The network interface couples the computer to the communications network 14. The computer also comprises a power supply 214. Programs are stored in the main memory 240 and executed by the CPU 222.

The server 6 may have the same construction but may omit the human interface devices, display driver and display.

The mobile phone may have a similar construction with the addition of wireless communications hardware and software.

Power Control Policy

A power control policy may affect the power scheme which in turn affects the way the operating system schedules CPU cycles. That occurs at a level in the hierarchy of levels of organization of a computer below the kernel of the Operating System.

A power control policy may provide settings for power control implemented by the operating system.

Variants

The above embodiments are to be understood as illustrative examples of the invention. Further embodiments of the invention are envisaged. For example:—

a) The target machine 2 has been described as a desktop machine but it could be a laptop, tablet computer, server, mobile telephone or any other machine requiring a policy;

b) The user's current machine has been described as a smart mobile phone but it could be a laptop, tablet computer, server, or any other machine able to contact the shopping server and select a policy from a list.

c) The example of providing a policy referred to a power control policy. However any other type of policy may be provided to the target machine.

d) The invention may be used to provide policies of any type to any type of computing device. One example is a security system for a building and the policy is settings for the system, for example times of activation and de-activation of the system. Another example is a climate control system for a building and the policy is time settings for the system.

e) The shopping server 6 may be used to provide application programs to the users in addition to policies.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of providing a policy to a target computer in a network with a plurality of computers including a first computer, a target computer, a source of data defining a plurality of policies, and an installing arrangement which installs policies on the computers of the network, the method comprising:
accessing the source from the first computer and selecting one of the policies for provision to the target computer;
responding, by the source, to the selection to provide the selected policy to the installing arrangement; and
automatically installing the selected policy on the target computer using the installing arrangement.

2. The method according to claim 1, wherein the computers of the network are associated with respective identifiers of users, such an identifier being provided from the first computer to the source and the selected policy being installed on the target computer identified by the identifier.

3. The method according to claim 2, wherein the source identifies the target computer from data stored in a data store of the network correlating identifiers of users with identifiers of computers of the network.

4. The method according to claim 3, wherein the said data store is an asset database of the network.

5. The method according to claim 1, wherein the first computer has a web browser and the web browser is used to access a list of policies provided by the source and to select a policy from the list for installation on the target computer.

6. The method according to claim 1, wherein the first computer is a laptop, tablet computer, mobile telephone, or any other mobile computer.

7. The method according to claim 1, wherein the first computer is a desktop computer or workstation.

8. The method according to claim 1, wherein the source comprises a server storing at least policies for the computers of the network.

9. The method according to claim 1, wherein the installing the arrangement comprises a network management tool and the policy is provided to the tool by the said source together with the identifier of the target computer.

10. A network, comprising:
a plurality of computers, including:
a first computer,
a target computer,
a source of data defining a plurality of policies, and
an installing arrangement which installs policies on the computers of the network,
wherein the first computer has program code for accessing the source from the first computer and for selecting one of the policies for provision to the target computer,
wherein the source has program code for responding to the selection to provide the selected policy to the installing arrangement, and
wherein the installing arrangement has program code for automatically installing the selected policy on the target computer.

11. A network according to claim 10, wherein the source identifies the target computer from data stored in a data store of the network correlating identifiers of users with identifiers of computers of the network.

12. A network according to claim 11, wherein the data store is an asset database of the network.

13. A network according to claim 10, wherein the first computer has a web browser and the web browser is used to access a list of policies provided by the source and to select a policy from the list for installation on the target computer.

14. A network according to claim 10, wherein the first computer is a laptop, tablet computer, mobile telephone, or any other mobile computer.

15. A network according to claim 10, wherein the first computer is a desktop computer or workstation.

16. A network according to claim 10, wherein the source comprises a server storing at least policies for the computers of the network.

17. A network according to claim 10, wherein the installing arrangement comprises a network management tool and the policy is provided to the tool by the source together with the identifier of the target computer.

18. A network according to claim 10, wherein the installing arrangement comprises installation software at the source.

19. A network according to claim 10, wherein the network comprises a power control system and the power control system includes the installing arrangement.

20. A network according to claim 19, wherein the power control system includes a store for storing power control policies and a stored policy is provided to the target computer in accordance with the selection.

21. A network according to claim 10, wherein the target computer comprises an agent responsive to the selected policy to change power control settings at the target computer.

22. A network according to claim 10, wherein respective computers are associated with respective identifiers of users, such an identifier is provided from the first computer to the source and the selected policy is installed on the target computer identified by the identifier.

23. A non-transitory computer readable medium storing instructions which, when run on a computer in a network with a plurality of computers including a first computer, a target computer, a source of policies and an arrangement which installs policies on the computers of the network, execute a method that:
responds to a request from the first computer to require an identifier of the user of the target computer;
on receipt of the identifier of the user, accesses from the asset database the identifier of the target computer;
in response to the identifier of the target computer, provides to the first computer a list of policies appropriate to the identified target machine; and
responds to selection of a policy at the first computer to provide the selected policy and the identifier of the target computer to the installing arrangement.

24. The method according to claim 1, wherein the installing arrangement comprises installation software at the source.

25. The method according to claim 1, wherein the network comprises a power control system and the power control system includes the installing arrangement.

26. The method according to claim 25, wherein the power control system includes a store for storing power control policies and a stored policy is provided to the target computer in accordance with the said selection.

27. The method according to claim 1, wherein the target computer comprises an agent responsive to the selected policy to change power control settings at the target computer.
